(19) United States
(12) Patent Application Publication
(10) Pub. No.: US 2017/0085768 A1
(43) Pub. Date: Mar. 23, 2017

(54) AN IMAGE CAPTURING SYSTEM, A KIT FOR AN IMAGE CAPTURING SYSTEM, A MOBILE PHONE, USE OF AN IMAGE CAPTURING SYSTEM AND A METHOD OF CONFIGURING A COLOR MATCHED LIGHT SOURCE

(71) Applicant: PHILIPS LIGHTING HOLDING B.V., EINDHOVEN (NL)

(72) Inventors: Arjen Gerben VAN DER SIJDE, EINDHOVEN (NL); Nicola Bettina PFEFFER, EINDHOVEN (NL); Yourii MARTYNOV, EINDHOVEN (NL); Charles Andre SCHRAMA, EINDHOVEN (NL)

(21) Appl. No.: 15/312,231

(22) PCT Filed: Apr. 30, 2015
(86) PCT No.: PCT/EP2015/059440

§ 371 Date: Nov. 18, 2016

(30) Foreign Application Priority Data
May 20, 2014 (EP) 14169118.8

(51) Int. Cl. H04N 5/235; H05B 33/08; H05B 37/02; H04N 5/225; H04N 9/04

(52) U.S. Cl. CPC H04N 5/2354; H04N 5/2256; H04N 9/04; H04N 5/2351; H05B 37/0218; H05B 33/0872; H05B 33/0854

(57) ABSTRACT

An image capturing system (300), a kit for an image capturing system, a mobile phone, a use of an image capturing system and a method of configured a color matched light source are provided. The image capturing system obtains captured images having a substantially equal color reproduction in a portion illuminated by ambient light (L1) and a portion illuminated by a color matched light source (305). The image capturing system comprises an image capturing sensor (310), a controller (340) and the color matched light source. The color matched light source (305) comprises a first light source (320) and a second light source (330. The light emission spectra of the first and second light source are selected such that, in a color space of the image capturing sensor, a line between their color points is for a large part close to the locus line, while the first or second light source are at a distance from the locus line.

### FIELD OF THE INVENTION

The invention relates to an image capturing system, to a kit for an image capturing system, to a mobile phone, to a use of an image capturing system and to a method of configuring a color matched light source.

### BACKGROUND OF THE INVENTION

Cameras are often provided with a flash for illuminating a scene when an image is to be captured in relatively dark circumstances. Today many cameras of mobile electronic device, for example, mobile phones are provided with a high current Light Emitting Diode (LED) that is provided with a phosphor material for converting some of the light of the LED towards light of another color such that substantially white light can be generated. The LED with phosphor is capable of generating during a relatively short period of time a relatively intense beam of light for illuminating a relatively dark scene.

It is known to select a specific LED with phosphor as the flash of a camera such that, seen with the human naked eye, the light of the flash matches with a predefined environmental light. When the scene that has to be captured is partly illuminated by ambient light and partly illuminated by the flash of the camera, the human naked eye has equal color experiences in the different parts. It is assumed that this also results in a good match of colors in the different parts by the camera. The LED with phosphor is only matched with one environmental lighting condition.

It is also known to select two different LEDs with phosphor as the flash and to use a controller to determine the amount of light to be emitted by each one of the two different LEDs such that the light of the flash substantially matches with white light (as perceived by the human naked eye) of a required color temperature. When the scene that has to be captured is partly illuminated by white light of a specific color temperature and partly illuminated by the flash with two different LEDs, the human naked eye has equal color experiences in the different parts. It is assumed that this also results in a good match of colors in the different parts by the camera.

Published patent application US2010/0254692A1, which is incorporated by reference, discloses a camera illumination device. The camera illumination device has at least two different light sources each emitting a different color distribution. The camera illumination device further comprises an image sensor for obtaining information about the average illumination conditions of a scene at a moment in time that the at least two different light sources do not emit light. A controller of the camera illumination device subsequently determines on basis of the image sensor how the at least two different light sources should be driven to emit by the at least two different light source a light emission that matches the average illumination conditions of the scene. Then the camera illumination device is able to increase the intensity of the light that illuminates the scene without changing other characteristics of the illumination.

The inventors have found that when the color point of the light generated by the camera illumination device and the color point of the average lighting conditions are matched to each other in the CIEXYZ color space (which is a color space that represents how the human naked eye experiences different color of light), the captured image shows color differences. In general, a part of the image that represents a portion of the scene that is illuminated by the camera illumination device looks more purple or green to the human naked eye than a part of the image that represents a portion that is illuminated by the ambient light.

US2011/292239 describes capturing an image on a mobile device having a flash comprising a red light source and a white light source. A detection of a color spectrum of ambient light is made using image data sensed by an image sensor. Additionally, a determination of an intensity of red light when combined with an associated intensity of white light results in a color spectrum that substantially matches the color spectrum of the ambient light. The flash emits white light from the white light source of the flash and red light from the red light source of the flash. An image from a camera module is recorded during the emission of the white and red light.

US2013/0221866 describes an illuminating device comprising a plurality of semiconductor light-emitting devices differing in emission color, wherein outputted light is combined. The devices emit light on the basis of an emission from the semiconductor light-emitting element and phosphor which is excited by emission from the semiconductor light-emitting element to fluoresce. The deviation Δuv from a blackbody radiation locus is within a range of −0.02 to 0.02 in the uv chromaticity diagram according to UCS (u,v) color system (CIE 1960).

### SUMMARY OF THE INVENTION

It is an object of the invention to provide to provide an improved image capturing system having a flash light source with two controllable light sources which shows less color differences in a captured image between a portion of the captured scene that is illuminated by ambient light and another portion of the captured scene that is illuminated by a flash light source of the image capturing system.

According to an aspect of the invention, an image capturing system is provided as defined in the claims. According to a further aspect of the invention, a kit is provided as defined in the claims. According to another aspect of the invention, a use of an image capturing system is provided as defined in the claims. According to a further aspect of the invention, a mobile phone is provided as defined in the claims. According to another aspect of the invention, a method of configuring a color matched light source is provided as defined in the claims. Advantageous embodiments are defined in the dependent claims.

The image capturing system according to an aspect of the invention is for obtaining a captured image having a substantially equal color reproduction in a portion illuminated by ambient light and a portion illuminated by a color matched light source of the image capturing system. The image capturing system comprises an image capturing sensor, a color matched light source and a controller. The image capturing system is for capturing a captured image comprising pixels. The image capturing sensor is configured to obtain color values relating to different color components for the pixels according to spectral responses for the different colors components. For example, the color capturing sensor uses a Bayer pattern filter arrangement of comprises different color filters in a specific pattern. The color values of a single pixel represent a specific color point in the color space of the image capturing sensor. The color matched light source is for use as a flash light source of the image capturing system and comprises a first light source and a second light source. The first light source has a first light emission spectrum having a first color point in the color space of the image capturing sensor. The second light source has a second light emission spectrum having a second color point in the color space of the image capturing sensor.

The controller is configured to receive characteristics of the ambient light, the characteristics being indicative of a correlated color temperature of the ambient light, an estimated color point of the ambient light or a color distribution of the ambient light, and in dependence of the received characteristics of the ambient light, determine control signals for controlling a light emission of the first light source and of the second light source to obtain a combined light emission matching the characteristics of the ambient light.

The first light emission spectrum and the second light emission spectrum are selected for emitting light that is, in the color space of the image capturing sensor, close to a locus line in a dynamic range of which borders are defined by a first reference color point of a black body radiator having a first temperature and a second reference color point of a black body radiator having a second temperature such that the first color point is at least a predefined distance away from the locus line or the second color point is at least the predefined distance away from the locus line, and line between the first color point and the second color point at least partially intersects with a first area and a second area, the first area being up to the predefined distance from the first reference color point, the second area being up to the predefined distance from the second reference color point.

The predefined distance is smaller than 0.05. The first temperature is in a range from 5,000 to 20,000 Kelvin and the second temperature is in a range from 1,500 to 3,500 Kelvin. The color space of the image capturing sensor is represented by a two dimensional color space wherein color points represent red and green color values as a portion of a sum of the red, green and blue color values (i.e. amounts of red and green light normalized for the sum red, green and blue light—formulas are provided in the detailed description of the Figures, for example, formulas (3) and (4) can be used to calculate the value for red and green). The locus line represents color points of light emitted by black body radiators having different temperatures.

The color matched light source is capable, depending on the determined control signals, to emit light with a color point on the line from the first color point to the second color point. In particular, by controlling the first light source to emit a specific amount of light and by controlling the second light source to emit another specific amount of light, light can be generated that has a color point in between the first area and the second area. Because the first area and the second area are located close to color points of black body radiators having a specific temperature (i.e. within the predefined distance), a portion of the line in between the first area and the second area is, in the color space of the image capturing sensor, close to the locus line. Thus, the image capturing system is capable of emitting light that is close to the locus line in the dynamic range of which borders are defined by the light emitted by the black body radiator having the first temperature called a first reference color point and the light emitted by the black body radiator having the second temperature called a second reference color point.

The effect of the above selection of light sources is that, although the light sources as such need not be close to the locus line, the emitted light of the combined light source is, at the boundaries of said dynamic range said dynamic range, within a required predefined distance from the locus line in the effective color space of the sensor. This is achieved by applying light sources that are, as such, not close to the locus line but are selected so that the connecting line is within the predefined distance from the locus line at the reference color points. This enables generating respective control signals so that the combined light, in the color space of the sensor and within the required dynamic range of color temperatures, is close to the locus line within said required predefined distance. Advantageously, the combined light will be effectively matched to the ambient light as perceived by the respective sensor. Also, light sources and phosphors in such sources may be selected in an enlarged range without the requirement to be within said required predefined distance to the locus line, which reduces the cost of the system.

The light of black body radiators having different temperatures is, in general, defined as white light. Because the connecting line between the first color point and the second color point is close to the locus line in the color space of the image recording sensor, the color matched light source is, in dependence of the control signals of the controller, capable of emitting light that is captured by the image recording sensor as relatively white light. Often, the ambient lighting conditions are based on relatively white light, such as natural daylight or light from light sources that emit relatively white light. Thus, when the ambient light is relatively white light, the image capturing system enables the illumination of the scene to be captured with light that is captured by the image recording sensor as relatively white light as well and, thus, no distinct color differences can be seen in the captured image between different portions illuminated by the color matched light source and the ambient light, respectively.

It is to be noted that the combined light emission is emitted, in use, by the color matched light source. Based on the determined control signals, the combined light emission only comprises light emitted by the first light source, only comprises light emitted by the second light source, or comprises light of both the first light source and the second light source. The control signals also determine, when the combined light emission comprises light of both the first light source and the second light source, how large the contribution of the light of the first light source and how large the contribution of the light of the second light source is.

In the above discussed image capturing system, the predefined distance is measured in the color space of the image recording sensor when the color space is reduced to a two-dimensional space formed by the normalized r (red) and g (green) value of (relevant) color points. In the detailed description of the drawings formula's (3) and (4) define hoe such r (red) and g (green) values can be calculated.

In the above discussed image capturing system, the color matched light source is directly or indirectly coupled to controller such that the determined control signals actually control the amount of light emitted by the light sources of the color matched light source. In between the controller and the light source a driving circuitry may be provided that drives the light sources with a specific amount of electrical energy to obtain the emission of a specific amount of light as indicated by the control signals.

The line that connects the first color point and the second color has to intersect with areas around color points of specific black body radiators (having temperatures in specific intervals). This requirement on the location of the first color point and the second color point has implications for the light that the first light source and the second light source can emit. In the color space of the image recording sensor this means that the first color point and the second color point cannot be a color points of a light emitter emitting a single or a few wavelengths of light. In other words, the first light source and the second light source cannot be a blue, red or green emitting light source. For example, the first light source has, at least, to emit some blue light and some green/greenish light to obtain the first color point. For example, the second light source has, at least, to emit some red light and some light in the yellow/greenish spectral range to obtain the second color point. This means that light emissions of the first light source and the second light source are no light emission with a relatively narrow light emission spectrum (e.g. of a relatively saturated color) but comprise energy in the form of light at a relatively large number of wavelengths. Thus, the light emitted by the first light source and by the second light source do not have a low color rending index, and, thus, the combined light emission does also not have a low color rendering index. Thus, besides the fact that the color rendering is about equal in parts of the captured image illuminated by the ambient light and parts illuminated by the color matched light source, the rendered color are also revealed in the captured image in a natural way. Optionally, the light emitted by the first light source and/or the light emitted by the second light source have a color rending index that is larger than 60, or is optionally larger than 70, or is optionally larger than 80. For best color reproduction, a careful choice of light source spectra allows to minimize the distance of the reproduced colors in e.g. La*b* space or any other color difference space.

Optionally, the predefined distance is smaller than 0.04. Optionally, the predefined distance is smaller than 0.03. Optionally, the first temperature is in a range from 5,000 to 15,000 Kelvin. Optionally, the first temperature is in a range from 5,000 to 12,000 Kelvin. Optionally, the first temperature is 10,000. Optionally, the second temperature is in a range from 1,500 to 3,000 Kelvin. Optionally, the second color temperature is in a range from 2,000 to 2,700 Kelvin. Optionally, the second color temperature is 2,200 Kelvin.

Optionally, the first color point is within the first area. Optionally, the second color point is within the second area.

Optionally, the first light emission spectrum has a first further color point in the CIEXYZ color space and the second light emission spectrum has a second further color point in the CIEXYZ color space A line between the first further color point and the second further color point intersects at least partially with a first further area and with a second further area. The first further area being defined by in the CIEXYZ color space by the predefined distance to a color point on a black body line of light emitted by a black body radiator having the first temperature. The second further area being defined in the CIEXYZ color space by the predefined distance to a color point on the black body line of light emitted by a black body radiator having the second temperature. When these conditions are also fulfilled in the CIEXYZ color space, the human naked eye will experience the light emitted by the color matched light source also as relatively white light.

Optionally, the first light emission and the second light emission are selected such that all color points on a portion of the line between the first area and the second area have a shortest distance to the locus line that is smaller than the predefined distance. Thus, when the controller generates specific control signals, it is guaranteed that the light emitted by the color matched light source is captured by the image recording sensor as relatively white light. Note that this shortest distance is measure in the color space of the image capturing sensor when being represented by the (normalized) r (Red) and g (Green) values.

Optionally, the first light emission and the second light emission are selected such that an average of all shortest distances from the color points on the portion of the line to the locus line is minimized. The average shortest distance is an average of all shortest distances between color points on the portion of the line to a nearest point on the locus line.

The two above provided optimization criterion for selecting the first light emission and the second light emission relate to the color space of the image recording sensor. Optionally, the two above provided optimization criterion for selecting the first light emission and the second light emission also apply in the CIEXYZ color space for selecting the first light emission and the second light emission.

Optionally, the color matched light source further comprises a third light source having a third light emission spectrum having a third color point in the color space of the image capturing sensor. The third light emission spectrum is selected to have a green value for the third color point that is larger than the maximum green value of all color points on the locus line. The controller is further configured to determine, in dependence of the received characteristics of the ambient light, the control signals that comprise a control signal for controlling a light emission of the third light source to obtain the combined light emission.

Thus, in addition to the first light source and the second light source, the color matched light source comprises the third light source. This enables the color matched light source to emit combined light emissions that have a color point within a triangle defined by the first color point, the second color point and the third color point. Thus, a relatively good match can be made between the light emitted by the color matched light source and the ambient light (seen in the color space of the image capturing sensor). The locus line is in the color space of the image capturing sensor in general a bumped curved line describing a hill. Because the third color point is above the locus line, a significant portion of the bumped curved locus line is within the triangle. This provides the controller with the opportunity to generate control signals for the color matched light source such that the combined light emission in dependence of these control signals has a color point (in the color space of the image capturing sensor) that is substantially on the locus line. Thereby the emitted light is white light (as captured by the image capturing sensor) and, in particular when the ambient light is also relatively white light, the combined light emission spectrum may well match the ambient light when being captured by the image capturing sensor. Furthermore, when the characteristics of the ambient light directly or indirectly indicate that the ambient light has, in the color space of the image recording sensor, a color point somewhere else within the triangle, the controller is able to determine control signals that lead to the emission of a combined light emission that well matches the ambient light when being captured by the image capturing sensor. For example, when the ambient light is TL light, the color point of the ambient light is in general not on the locus line and even in this situation the image capturing system is capable of emitting flash light that well matches the TL light in the color space of the image capturing sensor. Thus, the color reproduction in portions of the captured image is about the same for different portions illuminated by either the ambient light or the color matched light source.

For sake of clarity, in accordance with this optional embodiment, the combined light emission of the color matched light source, in dependence of the control signals, comprises light of the first light source, of the second light source and/or of the third light source.

Optionally, the third color point has a predefined second distance to a nearest point of the locus line, the predefined second distance is smaller than 0.15. According to this optional embodiment, the third color point is a color point relatively close to the locus. Thus, the third light emission spectrum is not a relatively narrow light emission spectrum but comprises energy in the form of light at a relatively large number of wavelengths. Thus, the color rendering index of the third light emission is not low, and thereby the color rendering index of the combined light emission is sufficient large. Optionally, the light emitted by the third light source has a color rendering index that is larger than 60, or which is optionally larger than 70, or which is optionally larger than 80. For best color reproduction, the careful choice of light source spectra allows to minimize the distance of the reproduced colors in e.g. L*a+b* space or any other color difference space.

Optionally, the third color point has a red-value in a range from 0.2 to 0.4. Note that this red-value relates to the above discussed color space of the image capturing sensor and that the color space is represented by a two-dimensional space defined by the (normalized) r (Red) and g (Green) values.

It is to be noted that embodiments of the image capturing system are not limited to embodiments of the color matched light source with two or three light source. An advantageous color matched light source having more than three light sources can also be used in the image capturing system comprising at least the first light source, the second light source and third light source as discussed above.

Optionally, the first light emission spectrum, the second light emission spectrum and the third light emission spectrum are selected to obtain a triangle that at least overlaps a portion of the locus line. The triangle is defined by the first color point, the second color point and the third color point. The portion of the locus line representing color points of light emitted by different black body radiators having different temperatures in a range from 2,700 Kelvin to 6,500 Kelvin. This optional embodiment enables the light emission of relatively white light (when being captured by the image capturing sensor) in a relatively wide range of temperatures of black body radiators. Optionally, the portion of the locus line representing color points of light emitted by different black body radiators having different temperatures in a range from 2,500 Kelvin to 10,000 Kelvin. Optionally, the portion of the locus line representing color points of light emitted by different black body radiators having different temperatures in a range from 2,000 Kelvin to 15,000 Kelvin. Optionally, the portion of the locus line representing color points of light emitted by different black body radiators having different temperatures in a range from 1,500 Kelvin to 15,000 Kelvin.

It is to be noted that it has been mentioned that the triangle is defined by three different color points. This means that the three different color points form the corners of the triangle.

Optionally, the controller is further configured to determine the control signals to obtain the combined light emission having a combined light emission spectrum that has in the color space of the image capturing sensor a combined color point that is close to the locus line (representing color points of light emitted by black body radiators having different temperatures). Thus, not only the color points of the first, second and third light source are selected such that the color matched light source may emit relatively white light (when being captured by the image capturing sensor) when only one of the light source is controlled to emit light, but the controller is also configured to obtain such a light emission when the controller controls both the first light source and the second light source to emit light. Thereby the controller still takes into account the characteristics of the ambient light. This embodiment applies to color matched light sources having 2, 3 or more light source.

Optionally, the controller is further configured to determine the control signals to obtain the combined color point of which a shortest distance from the combined color point to the locus line is smaller than the predefined distance. Thus, not only the color points of the first, second and third light source are selected such that the color matched light source may emit relatively white light (when being captured by the image capturing sensor), but the controller is also configured to obtain a combined light emission that represents relatively white light. Thereby the controller still takes into account the characteristics of the ambient light. This embodiment applies to color matched light source having 2, 3 or more light source.

Optionally, the received characteristics of the ambient light comprise a correlated color temperature value of the ambient light and the controller is configured to determine the control signals to obtain the combined light emission having a combined light emission spectrum that has in the color space of the image capturing sensor a combined color point for which a distance between the combined color point to a color point (in the color space of the image capturing system) of a black body radiator having a temperature substantially equal to the correlated color temperature is substantially minimized. This optional embodiment provides a relatively good match between the ambient light and the light emitted by the color matched light source to prevent color reproduction differences within the captured image.

Optionally, the controller is further configured to determine a fourth color point of the ambient light in the color space of the image capturing system, and the controller is further configured to determine the control signals to obtain the combined light emission having a combined light emission spectrum that has in the color space of the image capturing sensor a combined color point for which a distance between the combined color point to the fourth color point is substantially minimized. This optional embodiment provides a relatively good match between the ambient light and the light emitted by the color matched light source to prevent color reproduction differences within the captured image.

Optionally, the first light source comprises a first solid state light emitter for emitting light having a first color distribution and comprises a first luminescent material arranged to receive light emitted by the first solid state light emitter, configured to absorb a portion of the light of the first color distribution and configured to convert a portion of the absorbed light towards light of a second color distribution being different from the first color distribution. The amount of the first luminescent material and an arrangement of the first luminescent material with respect to the first solid state light emitter are selected to obtain the first light emission spectrum that is the combination of the light of the second color distribution and a non-absorbed portion of the light of the first color distribution. In other words, a specific amount of the first luminescent material is arranged at such a position with respect to the first solid state light emitter to obtain an amount of light the second color distribution that forms together with an amount of non-absorbed light of the first color distribution the first light emission spectrum of the first light source.

Optionally, the second light source comprises a second solid state light emitter for emitting light having a third color distribution and comprises a second luminescent material arranged to receive light emitted by the second solid state light emitter, configured to absorb a portion of the light of the third color distribution and configured to convert a portion of the absorbed light towards light of a fourth color distribution being different from the third color distribution. The amount of the second luminescent material and an arrangement of the second luminescent material with respect to the second solid state light emitter are selected to obtain the second light emission spectrum that is the combination of the light of the fourth color distribution and a non-absorbed portion of the light of the third color distribution.

Optionally, third light source comprises a third solid state light emitter for emitting light having a fifth color distribution and comprises a third luminescent material arranged to receive light emitted by the third solid state light emitter, configured to absorb a portion of the light of the fifth color distribution and configured to convert a portion of the absorbed light towards light of a sixth color distribution being different from the fifth color distribution. The amount of the third luminescent material and an arrangement of the third luminescent material with respect to the third solid state light emitter are selected to obtain the third light emission spectrum that is the combination of the light of the sixth color distribution and a non-absorbed portion of the light of the fifth color distribution.

With relatively simple and price effective means, namely solid state light emitters and luminescent materials, light sources are obtained. The solid state light emitters are, for example, a Light Emitting Diode (LED), or an Organic Light Emitting Diode (OLED), or a laser diode. The luminescent materials may be an inorganic phosphor or an organic phosphor. Alternatively, the first luminescent material comprises particles showing quantum confinement, such as, for example, Quantum Dots.

Optionally, the image capturing system comprises at least one of: i) an ambient light sensor for determining characteristics of the ambient light, the ambient light sensor being coupled to the controller, and ii) a light source driving circuit for driving the first light source and the second light source according to the control signals received from the controller. Alternatively, the image capturing sensor may also be configured to determine, optionally in cooperation with the controller, characteristics of the ambient light and to provide the characteristics of the ambient light to the controller.

According to a further aspect of the invention, a kit for an image capturing system is provided. The kit comprises the color matched light source and the image capturing sensor as described above in the image capturing system for obtaining a captured image having a substantially equal color reproduction in a portion illuminated by ambient light and a portion illuminated by the color matched light source. Optionally, the kit may also comprise a controller as defined in previous embodiments.

The kit has similar embodiments to the embodiments of the image capturing system and the embodiments provide about the same effects and about the same benefits as the embodiments of the image capturing system. The kit is a semi-finished product which may be used to build an image capturing system according to one of the above discussed embodiments. It is to be noted that the color matched light source may also be provided separately of the image capturing sensor, assuming that it has been defined for which predefined image capturing sensor the color matched light source is designed.

Optionally, the color matched light source of the kit further comprises a third light source having a third light emission spectrum having a third color point in the color space of the image capturing sensor. The third light emission spectrum is selected to obtain a green value for the third color point that is larger than the maximum green value of all color points on the locus line. Optionally, the third color point has a red-value in a range from 0.2 to 0.4. Optionally, the third color point has a predefined second distance to a nearest point of the locus line. The predefined second distance is smaller than 0.15.

According to another aspect of the invention, a mobile phone is provided which comprises an image capturing system according to one of the above described embodiments, or which comprises a kit according to one of the above described embodiments. The mobile phone has similar embodiments to the embodiments of the image capturing system or to the embodiments of the kit and the embodiments of the mobile phone provide about the same effects and about the same benefits as the embodiments of the image capturing system or the embodiments of the kit.

According to a further aspect of the invention, a use of the image capturing system comprising the image capturing sensor and the color matched light source as described above to capture an image being partially illuminated by ambient light are provided. The use further comprising using a controller to i) receive characteristics of the ambient light and ii) in dependence of the received characteristics of the ambient light, determine the control signals for controlling a light emission of the first light source and of the second light source to obtain a combined light emission. Optionally, the above discussed use of the color matched light source may also comprise using a color matched light source that has a third light source as, for example, defined in embodiments of the image capturing system. Then the controller also generates a control signal for controlling the light emission of the third light source.

According to a further aspect of the invention, a method of configuring a color matched light source for use as a flash light source in an predefined image capturing system. The predefined image capturing system is for obtaining a captured image having a substantially equal color reproduction in a portion illuminated by ambient light and a portion illuminated by a color matched light source of the image capturing system. The predefined image capturing system comprises an image capturing sensor. The color matched light source comprises a first light source and a second light source. The method comprising determining predefined spectral responses of the image capturing sensor of the image capturing system. The predefined spectral responses describe a response of the image capturing sensor to different colors while obtaining color values for pixels of a captured image, wherein the color values of a single pixel describe a specific color point in the color space of the image capturing sensor. The method further comprises determining a first color point in the color space of the image capturing sensor. The method further comprises determining a second color point in the color space of the image capturing sensor. The first color point and the second color point are determined for emitting light that is close to a locus line in a dynamic range of which borders are defined by a first reference color point of a black body radiator having a first temperature and a second reference color point of a black body radiator having a second temperature to obtain a line between the first color point and the second color point that at least partially intersects with a first area and a second area. The first area is up to the predefined distance from the first reference color point. The second area is up to the predefined distance from the second reference color point. The predefined distance is smaller than 0.05. The first temperature is in a range from 5,000 to 20,000 Kelvin. The second temperature is in a range from 1,500 to 3,500 Kelvin. The color space of the image capturing sensor is represented by a two dimensional color space based on an amounts of red and of green light relative to a total amount of light (i.e. amounts of red and green light normalized for the sum red, green and blue light). The locus line represents color points of light emitted by black body radiators having different temperatures. The method further comprises selecting the first light source, the first light source is configured to emit a first light emission having the determined first color point. The method further comprises selecting the second light source. The second light source is configured to emit a second light emission having the determined second color point.

The method of configuring a color matched light source enables the manufacturing of a kit according to one of the previously discussed embodiments and/or the manufacturing of an image capturing system according to one of the previously discussed embodiments. Therefore, the method provides similar embodiments as the embodiments of the kit and/or embodiment of the image capturing system and has similar effects and advantages as these embodiments.

Optionally, the color matched light source comprises a third light source and the method further comprises determining a third color point in the color space of the image capturing sensor, a green value of the third color point is larger than the maximum green value of all color points on the locus line. Optionally, the third color point has a red-value in a range from 0.2 to 0.4. Optionally, the third color point has a predefined second distance to a nearest point of the locus line. The predefined second distance is smaller than 0.15. The locus line represents color points of light emitted by black body radiators having different temperatures. The method further comprises selecting the third light source. The third light source is configured to emit a third light emission having the determined third color point.

Optionally, the selecting the first light source, the selecting of the second light source and/or the selecting of the third light source may comprises a) selecting a solid state light emitter for emitting light having a specific color distribution, b) selecting a specific luminescent material configured to absorb a portion of the light of the specific color distribution and configured to convert a portion of the absorbed light towards light of another specific color distribution being different from the specific color distribution, c) determining an amount of the specific luminescent material and a specific arrangement of the specific luminescent material with respect to the solid state light emitter to obtain the respective light source comprising the specific solid state light emitter and the specific luminescent material and the respective light source is configured to emit a combined light emission comprising the light of the another specific color distribution and a non-absorbed portion of the light of the specific color distribution, wherein the combined light emission has the respective color point of the respective light source.

Optionally, a computer program is provided which comprises instructions for causing a processor system to perform one of the above discussed methods. Optionally, the computer program is embodied on a data carrier.

These and other aspects of the invention are apparent from and will be elucidated with reference to the embodiments described hereinafter.

It will be appreciated by those skilled in the art that two or more of the above-mentioned options, implementations, and/or aspects of the invention may be combined in any way deemed useful.

Modifications and variations of the system, the method, the use, the mobile phone and/or of the computer program product, which correspond to the described modifications and variations of the system, can be carried out by a person skilled in the art on the basis of the present description.

### BRIEF DESCRIPTION OF THE DRAWINGS

In the drawings:

FIG. 1a schematically shows in a spectral diagram the sensitivity of the human naked eye to specific wavelengths of light,

FIG. 1b schematically shows in a spectral diagram an optional spectral response of an image capturing sensor to specific wavelengths of light,

FIG. 2a schematically shows a black body line and possible locations of a color point of, for example, ambient light in a CIEXYZ color space,

FIG. 2b schematically shows the black body line and possible location of the a color point of the ambient light in a color space of an image capturing sensor,

FIG. 3 schematically presents an example of an image capturing system,

FIG. 4 schematically presents in a color space of an image capturing sensor examples of the first color point and the second color point,

FIGS. 5a to 5d schematically present characteristics of light sources used in the example of a color matched light source of an example of the image capturing system,

FIGS. 6a to 6d schematically present characteristics of other exemplary light sources used in the example of a color matched light source of an example of the image capturing system,

FIG. 7 schematically presents another example of an image capturing system,

FIGS. 8a to 8d schematically present characteristics of light sources used in the another example of a color matched light source of an example of the image capturing system,

FIG. 9 schematically presents a method of configuring a color matched light source for use as a flash light source in a predefined image capturing system.

It should be noted that items denoted by the same reference numerals in different Figures have the same structural features and the same functions, or are the same signals. Where the function and/or structure of such an item have been explained, there is no necessity for repeated explanation thereof in the detailed description.

The Figures are purely diagrammatic and not drawn to scale. Particularly for clarity, some dimensions are exaggerated strongly.

### DETAILED DESCRIPTION

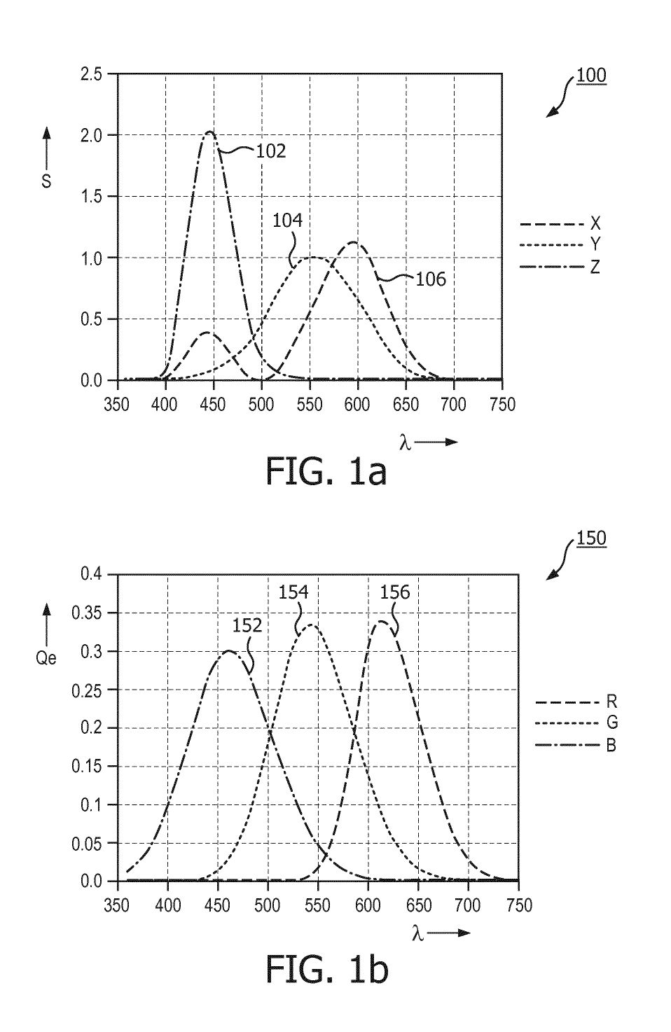

FIG. 1a schematically shows in a spectral diagram 100 the sensitivity of the human naked eye to specific wavelengths λ of light. The x-axis represents the different wavelengths λ of light and the y-axis represents the sensitivity S of the human naked to the specific wavelengths λ of light. The sensitivity values are directly associated with the chromatic response of the human naked eye to the specific wavelengths. In the spectral diagram 100 line 102 represents a chromatic response that mainly relates to wavelengths of blue light, line 104 represents a chromatic response that relates for a large part to wavelengths of green light, and line 106 represents a chromatic response that mainly relates to wavelengths of red light (but also slightly relates to the blue spectral range). The chromatic response are represented by the color matching functions x(λ), y(λ) and z(λ) which correspond to lines 106, 104, 102, respectively. The color matching functions x(λ), y(λ) and z(λ) define the CIEXYZ color space. When a light intensity spectrum I(λ) of, for example, light impinging on the human naked eye is known, the tristimulus values λ Y, Z can be calculated by the formulas:

X=∫x(λ)·I(λ)dλ

Y=∫y(λ)·I(λ)dλ

Z=∫z(λ)·I(λ)dλ (1)

Because the perception of color mainly relates to the ratios between the tristimulus values, a color point (x,y) of the light intensity spectrum I(λ) in the CIEXYZ color space is subsequently calculated by converting the absolute tristimulus values color into relative numbers by using the formula:

$$( x , y ) = ( \frac{X}{X + Y + Z} , \frac{Y}{X + Y + Z} ) \qquad ( 2 )$$

The response of the human naked eye to light is, in general, different to the response of image capturing sensors of image capturing systems (such as photo/film cameras). FIG. 1b schematically shows in a spectral diagram 150 an optional spectral response of an exemplary image capturing sensor to specific wavelengths λ of light. The x-axis represents the different wavelengths λ of light and the y-axis represents the quantum efficiency Qe of the exemplary image capturing sensor to specific wavelengths λ of light. In the spectral diagram 150 line 152 represents a chromatic response that mainly relates to wavelengths of blue light, line 154 represents a chromatic response that mainly relates to wavelengths of green light, and line 156 represents a chromatic response that mainly relates to wavelengths of red light. The chromatic response are represented by the color matching functions r(λ), g(λ) and b(λ) which respectively correspond to lines 156, 154, 152. The color matching functions r(λ), g(λ) and b(λ) define the color space of the exemplary image capturing sensor. When a light intensity spectrum I(λ) of, for example, light impinging on the image capturing sensor is known, the color values that are obtained by this exemplary image capturing sensor can be calculated by the formulas:

R=∫r(λ)·I(λ)dλ

G=∫g(λ)·I(λ)dλ

B=∫b(λ)·I(λ)dλ (3)

A color point (r, g) of the light intensity spectrum I(λ) in the color space of the exemplary image capturing sensor is subsequently calculated by:

$$( r , g ) = ( \frac{R}{R + G + B} , \frac{G}{R + G + B} ) \qquad ( 4 )$$

Thus, the values r (Red) and g (Green) of the color point are normalized color values with respect to the sum of the color values of red, green and blue. The combination of the color matching functions r(λ), g(λ) and b(λ) and formulas (3) and (4) define a two dimensional representation of the color space of the image capturing sensor that is represented by the normalized r (Red) and g (Green) values.

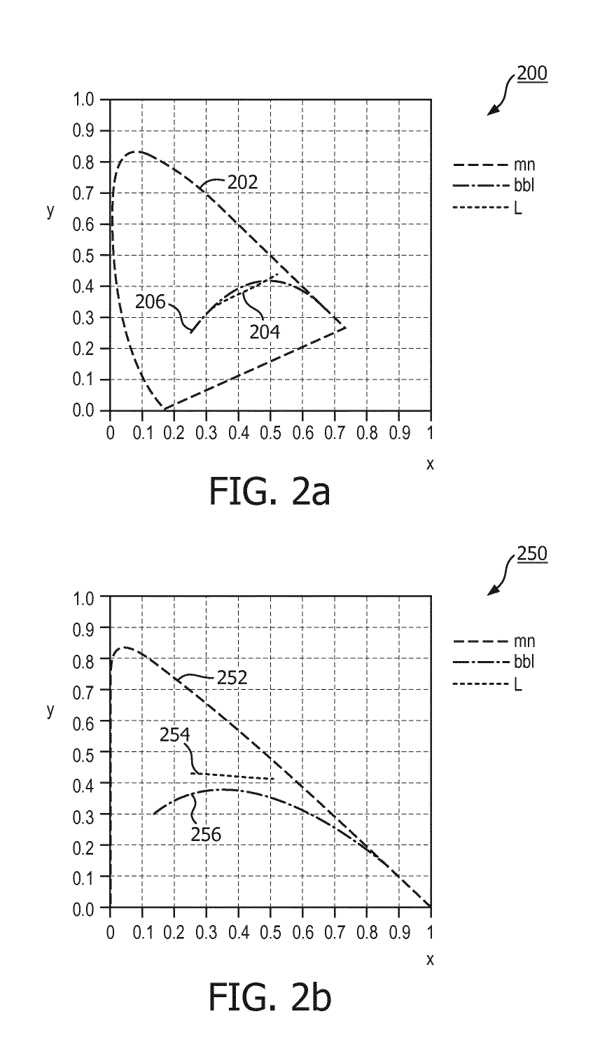

FIG. 2a schematically shows by means of line 202 the area in the CIEXYZ color space where color points of colors registered by the human naked eye can end up. Line 202, mn is often termed the “mono” because a large part of line 202 represents color points of a single wavelength of light. In FIG. 2a is also drawn the black body line 206, bbl. The black body line 206 represents color points of light emission spectra of black body radiators that have a specific temperature. Other terms used for the black body line 206 are “locus” or “Planckian locus”. In general, the human naked eye experiences light that has a color point on the black body line 206 as white light. Line 204, L is, for example, a line between a color point of a first light emitter and a color point of a second light emitter. By controlling the amount of light emitted by the first light emitter and the amount of light emitted by the second light emitter, substantially all color points on the line 204 can be emitted by the combination of the first light emitter, the second light emitter and a specific controlling and driving circuitry. Because the color points on line 204 are located close to the black body line 206, the human naked eye experiences the light emitted by these different light sources as substantially white light.

FIG. 2b schematically shows by means of line 252 the area in the color space of the exemplary image capturing sensor of FIG. 1b where color points of the line 204 end up in the color space of the exemplary image capturing sensor. Line 252, mn is the mono and represents for the largest part points of a single wavelength of light. When color points of light emission spectra of black body radiators having a specific temperature are drawn in the color space of the exemplary image capturing sensor, locus 256, bbl is obtained. In FIG. 2a, color points on line 204 are color point that can be generated by a combination of the first light emitter, the second light emitter and a specific controlling and driving circuitry. When for these examples of light emissions the color points are drawn in the color space of the exemplary image capturing sensor, line 254, L is obtained. It is seen that line 254 does not coincide with the locus 256. Thus, although the human naked eye experiences the light emissions of the different light sources as substantially white light, the exemplary image capturing sensor does not experience these light emissions as white light (note: in the color space of the exemplary image capturing sensor, it is assumed that the locus 256 defines white light). The exemplary image capturing sensor registers a more green color for the light emissions.

It is to be noted that a single color point, in either the CIEXYZ color space or in a color space of an image capturing sensor, can be obtained by an infinite number of different light (intensity) spectra I(λ). Thus, in the examples of FIGS. 2a and 2b, end points of lines 204, 254 represents specific light emissions of specifically selected first light emitter and a specifically selected second light emitter, but the same line 204 (in the CIEXYZ color space) may also be obtained by selecting different light emission of other light emitters. When the same line 204 is obtained, it is not by definition true that this also results in the same line 254 in the color space of the exemplary image capturing sensor. Thus, not all light (intensity) spectra I(λ) that result in the CIEXYZ color space in the same color point, result in the same color point in the color space of the image capturing sensor.

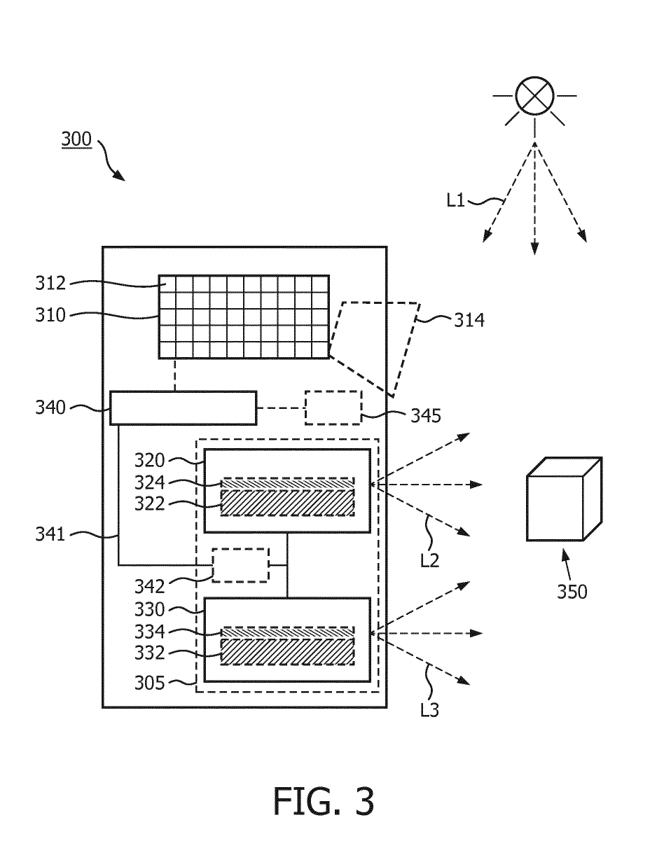

FIG. 3 schematically shows an image capturing system 300. The image capturing sensor has at least a predefined image capturing sensor 310 and a color matched light source 305. “Predefined” means in this context that it is defined beforehand which image capturing sensor 310 is used and it is optionally known what its characteristics are.

The predefined image capturing sensor 310 is configured for capturing images. The images are built up in the form of pixels. FIG. 3 schematically shows that the predefined image capturing sensor 310 captures color values for each pixel 312 of an array of pixels. It is to be noted that it is not required that the predefined image capturing sensor 310 has an array of pixels that directly maps on the pixels of a captured image. In the context of this invention it is only relevant that the image capturing sensor 310 registers incoming light according to specific spectral responses for different color components. For example, the predefined image capturing sensor 310 may comprise sensor elements that are sensitive for red, green and blue light according to, for example, the specific spectral responses (color matching functions) r(λ), g(λ) and b(λ) of FIG. 1b. The pixels of the image that is captured by the predefined image capturing sensor 310 have color values, for example, color values for red R, green G and blue B which are the results of the specific spectral responses r(λ), g(λ) and b(λ) being applied to received light intensity spectra. The specific spectral responses, such as the specific spectral responses r(λ), g(λ) and b(λ), define the color space of the image capturing sensor. The above discussed formulas (3) may be used to calculate what the obtained color values of a specific pixel will be when the light intensity spectrum I(λ) of the light received for that pixel is known. The above discussed formulas (4) may be used to calculate the color point of that specific pixel.

Optionally, the image capturing system 300 comprises optics 314 which transfer light received from a scene 350 to be captured to the predefined image capturing sensor 310.

The image capturing system 300 also comprises a controller 330 of which its function of controlling a color matched light source is discussed hereinafter. The controller 330 may further control the operation of the predefined image capturing sensor 310, such as providing a command to actually capture an image, and the controller 330 may receive the captured image from the predefined image capturing sensor 310.

The controller 330 receives at an input information about ambient light, L1. The image capturing system 300 may also comprise an ambient light sensor 345 that measures characteristics of the ambient light L1 and this ambient light sensor 345 may provide a signal to the controller which indicates the characteristics of the ambient light L1. Such characteristics are, for example, the correlated color temperature of the ambient light L1, or an estimated color point of the ambient light L1, or a color distribution of the ambient light L1, etc. Alternatively, the image capturing sensor 310 is used to determine characteristics of the ambient light L1. The image capturing sensor 310 may cooperate with the controller 340 to determine the characteristics of the ambient light L1. In such cooperation, for example, the image capturing sensor provides to the controller 340 a captured image of the scene 350 when the scene is only illuminated by the ambient light L1. Subsequently, the controller 340 may analyze the received image to calculate specific characteristics of the ambient light L1.

The color matched light source 305 is configured to operate as a flash of the image capturing system 300. This means that the color matched light source 305 is capable of emitting during short periods of time intense light beams. Also the color matched light source 305 may comprise optics (not shown) to shape the intense light beam and transmit the light emitted by the color matched light source 305 towards the scene 350 to be captured. The color matched light source 305 is directly or indirectly (e.g. via the driving circuitry 342) coupled to the controller 340 for receiving control signals and/or light source driving signals. The controller 330 controls when the color matched light source 305 emits the relatively short intense light beams and the control signals how the light of the different light sources must be missed into the relatively short intense light beams.

The color matched light source 305 comprises a first light source 320 and a second light source 330.

The first light source 320 is configured to emit, in use, light L2 having a first light emission spectrum that has a first color point in the color space of the image capturing sensor. When the first light emission spectrum is known and it is known what the spectral response of the image capturing sensor 310 are, formulas (3) and (4) may be used to calculate the first color point in the color space of the image capturing sensor 310. The first color point is located close to a color point of light emitted by a black body radiator having a first temperature. The first temperature is in a range from 5,000 to 20,000 Kelvin, optionally, in a range from 10,000 to 15,000 Kelvin. ‘Located close to’ means in this context that a distance from the first color point to the color point of the light emitted by the black body radiator having the first temperature is smaller than 0.05. This distance is measured in the color space of the image capturing sensor. The color space is expressed as a 2d dimensional space defined by the r (Red) and g (Green) values of the color point calculated in conformity with formulas (3) and (4). Optionally, the first light source 320 comprises a first solid state light emitter 322 and a first luminescent material 324. The first solid state light emitter 322 emits, in use, light of a first color distribution. The first luminescent material 324 is arranged to receive the light of the first color distribution and configured to absorb a portion of the received light and to convert the absorbed portion to light of a second color distribution. The first light emission spectrum of the light L2 is formed by the light of the second color distribution and a non-absorbed portion of the light of the first color distribution. It is to be noted that a specific first solid state light emitter 322 is selected in combination with a specific selection of the first luminescent material 324 to obtain the first light emission spectrum. Also the amount of the first luminescent material 324 and how the first luminescent material 324 is arranged with respect to the first solid state light emitter 322 are specifically selected to absorb a specific amount of the light of the first color distribution and to emit a specific amount of the light of the second color distribution such that the light L2 with the first light emission spectrum has the first color point.

The second light source 330 is configured to emit, in use, light L3 having a second light emission spectrum that has a second color point in the color space of the image capturing sensor. When the second light emission spectrum is known and it is known what the spectral response of the image capturing sensor 310 are, formulas (3) and (4) may be used to calculate the second color point in the color space of the image capturing sensor. The second color point is located close to a color point of light emitted by a black body radiator having a second temperature. The second temperature is in a range from 1,500 to 3,500 Kelvin, optionally, in a range from 1,800 to 2,700 Kelvin. ‘Located close to’ means in this context that a distance from the second color point to the color point of the light emitted by the black body radiator having the second temperature is smaller than 0.05. This distance is measured in the color space of the image capturing sensor. Optionally, the second light source 330 comprises a second solid state light emitter 332 and a second luminescent material 334. Embodiments of the second solid state light emitter 332 and the second luminescent material 334 are similar to and have similar characteristics to the embodiments of the first solid state light emitters 322 and the first luminescent material 324 as discussed above—a difference is that they are selected such that the second light source emits in use the second light emission spectrum having the second color point.

The first luminescent material 324 and/or the second luminescent material 334 are, for example, inorganic phosphors. An advantage of inorganic phosphors is that they emit light in a relatively wide color distribution, e.g., a color distribution that is wider than 70 nm (when expressed as a full width half maximum value). However, embodiments of the first luminescent material 324 and/or the second luminescent material 334 can also be organic phosphors and/or particles showing quantum confinement, such as, for example, Quantum Dots. Although Quantum Dots are in general narrow light emitters, it may be useful to combine them with, for example, a first luminescent material 324 that emits a relatively wide color distribution, to add some energy of light into the specific light emission spectrum of the color matched light source that are not present in the color distribution of the solid state light emitter and/or the color distribution of the (first) luminescent material. It is further to be noted that the first light source 320 and the second light source 330 may comprise more than one luminescent material for obtaining, for example, a better distribution of light energy over the different wavelengths of light to increase, for example, the color rendering index of the light emissions L2, L3 of the first light source 320 and the second light source 330. Optionally, the color rendering index of the light emissions L2, L3 of the first light source 320 and the second light source 330 is larger than 60. Optionally, the color rendering index of the light emissions L2, L3 of the first light source 320 and the second light source 330 is larger than 70.

The controller 340 is further configured to receive characteristics of the ambient light L1. As discussed above, the characteristics are received from the optional ambient light sensor 345 or from the image capturing sensor 310. Optionally, the controller 340 further processes the received characteristics to calculate, for example, a color point (in the color space of the image capturing sensor) of the ambient light L1. The controller 340 is further configured to determine control signals 341 for controlling a light emission of the first light source and of the second light source to obtain a combined light emission. The determining of the control signals 341 is performed in dependence of the received characteristics of the ambient light L1. The controller 340, for example, tries to obtain a combined light emission that matches as most as possible to the ambient light L1 in the color space of the image capturing sensor. The control signal 341 are provided to the color matched light source 305 or to an optionally provided driving circuitry 342. The driving circuitry 342 is configured to provide a specific amount of power to the first light source 320 and the second light source 330 according to the requirements indicated by the control signals 341. The driving circuitry 342, for example, provides a specific voltage or a specific current to the light source 320, 330 such that the light source emit a specific required amount of light. The driving circuitry 342 may also be configured to use pulse width modulation of the power provided to the light sources 320, 330 to control the amount of emitted light.

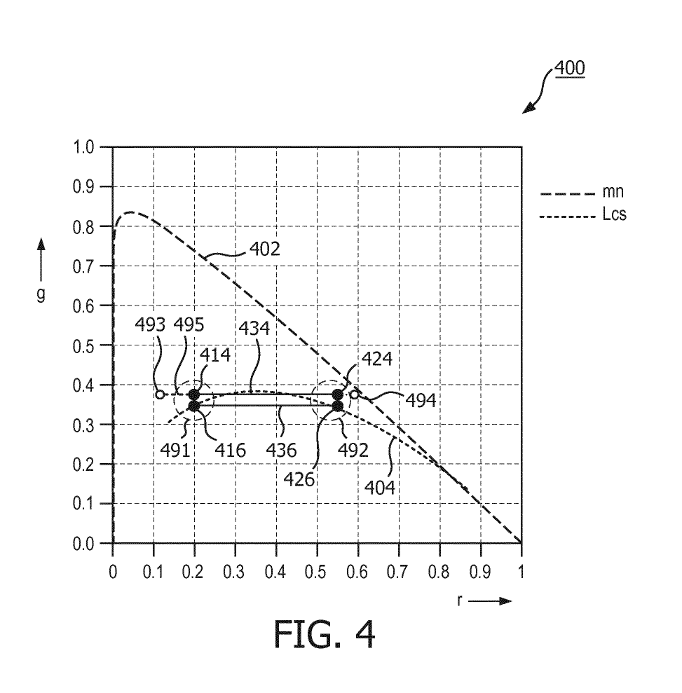

Please note that in the above the first color point and the second color point are present in a first area and second area, respectively. The first area is defined by a circle around a color point of a black body radiator having the first temperature and having a radius that is smaller than 0.05. The second area is defined by a circle around a color point of a black body radiator having the second temperature and having a radius that is smaller than 0.05. Consequently, a line between the first color point and the second color point at least partially intersects with the first area and the second area. The discussed effect of the image capturing system is a substantially equal color reproduction in different parts of a captured image, wherein one part of the image is illuminated by the ambient light and another part is illuminated by the color matched light source of the image matched light source. In order to achieve this effect, it is not necessary that the first color point is exactly in the first area and the second color point is exactly in the second area. In an advantageous embodiment of the image capturing system, the first color point and/or the second color point are located outside the first area and/or the second area, respectively, but the line between the first color point and the second color point intersects with the first area and the second area. Please note, the used word “line” refers to a “straight line”. In the following of the document it is assumed that the first color point is within the first area and the second color point is within the second area, however, in all the discussed embodiments, the first color point and the second color point can be located outside the first area and outside the second are. We one looks to the color space of the image capturing sensor as presented, for example, in FIG. 4, the first color point can be located more to the left and the second color point can be located more to the right. It is relevant in the context of this document whether the line between the first color point and the second color point at least partially overlaps with the first are and with the second area.

The image capturing system 300 may be embodied in mobile phone or another portable device which is capable of capturing images.

FIG. 4 presents in a chart 400 a color space of an example of an image capturing sensor in which a locus line 402, first color points and second color points are presented. The presented color space is drawn in a two-dimensional plot representing the r and g values of the color points. The r (Red) and g (Green) values of the color points may be determined by means of using formulas (3) and (4) that are discussed above. The x-axis represents the r (Red) values of the color points and the y-axis represents the g (Green) values of the color points. It is assumed that the color space is for a specific example of an image capturing sensor of which the spectral responses are known, e.g. the spectral responses of FIG. 1b. Line 402, mn is termed the “mono” line and is the border of an area that defines which color points the image capturing sensor is able to capture. The term “mono” refers to the fact that a large portion of line 402 represents color points of single wavelength light emission spectra. Line 404, lcs is termed the “locus” line. The locus line represents color points of light emitted by black body radiators having different temperature. Often the term black body line is used for line 404.

In chart 400 two examples are given of color points of embodiments of the first light source and the second light source as discussed in the context of FIG. 3. A first reference color point 416 which is located on the locus line close to a color point of light emitted by a black body radiator of about 10,000 Kelvin and a second reference color point 426 is also located on the locus line close to a color point of light emitted by a black body radiator of about 2,400 Kelvin. The reference color points define a dynamic range across which combined light of the light sources is required, in the color space of the image sensor, to be close to the locus line. A reference line 436 connects the first reference color point 416 and the second reference color point 426.

When the controller generates control signals to control the light emission of the first light source and of the second light source, a specific amount of first light of first color point is emitted and a specific amount of second light of the second color point are emitted. Depending on the ratio between the specific amounts of the first light and of the second light, the color point of the combined light emission (comprising the specific amounts of the first light and of the second light) is at a specific position on a connecting line between the color points of the light sources. The connecting line is close (within a required predefined distance) to the reference color points due to the selection of the light sources which need not be close to the locus line as explained below. The controller may be configured to optimize the choice of a point on the connecting line such that the color point of the combined light emission is within a distance of, for example, 0.05 from the locus line 404. Further, when the controller takes into account characteristics of the ambient light, the controller may optimize the choice of a point on the connecting line such that the combined light emission (having a color point on the connecting line) matches to a large extent to the characteristics of the ambient light. For example, a characteristic of the ambient light may be the correlated color temperature of the ambient light. Subsequently, the controller may determine a color point of light emitted by a black body radiator having that correlated color temperature (which is a point on the locus line 404) and minimize the distance from that color point to the color point of the combined light emission. For example, a characteristic of the ambient light may be the ambient light color point (expressed in the color space of the image capturing sensor), and the controller may be configured to select a point of the connecting line that is closest to the ambient light color point.

It is seen that the locus line 404 has a bumped curved shape, thus, when the first reference color point 416 and the second reference color point 426 are on the locus line 404, the reference line 436 between the first reference color point 416 and the second reference color point 426 is below the locus line 404. The choice of the first light source and the second light source may be optimized by selecting them slightly upwards with respect to the reference color points such that the line between the corresponding color points is close to the locus line 404. This is shown in an example wherein the first light source emits light that has in the color space of the image capturing sensor a first color point 414 and the second light source emits light that has in the color space of the image capturing sensor a second color point 424. The line 434 between the first color point 414 and the second color point 424 is now much closer to the locus line and, thus, when the controller selects a color point on line 434, the color matched light source emits light that is to a larger extend captured by the image capturing sensor as substantially white light.

The first reference color point is within a first area 491 and the second reference color point is within a second area 492. The first area 491 is up to a predefined distance from the first reference color point, e.g. defined by a circle around a color point of a black body radiator having the first temperature and having a radius that is smaller than 0.05. The second area 492 is up to the predefined distance from the second reference color point, e.g. defined by a circle around a color point of a black body radiator having the second temperature and having a radius that is smaller than 0.05. The first temperature and the second temperature are within the earlier discussed ranges. The effect of good color reproduction is obtained when the light sources are selected such that the first color point and the second color point are, for example, located on an extended connecting line 495 which is, for example, an extension of line 434. Now the first color point may be selected at least the predefined distance away from the locus line. Also the second color point may be selected at least the predefined distance away from the locus line. In that example the first color point of the first light source is, for example, color point 493 and/or the second color point of the second light source is, for example, color point 494. The extended connecting line 495 between color point 493 and color point 494 is selected to at least partially intersect with the first area 491 and the second area 492.

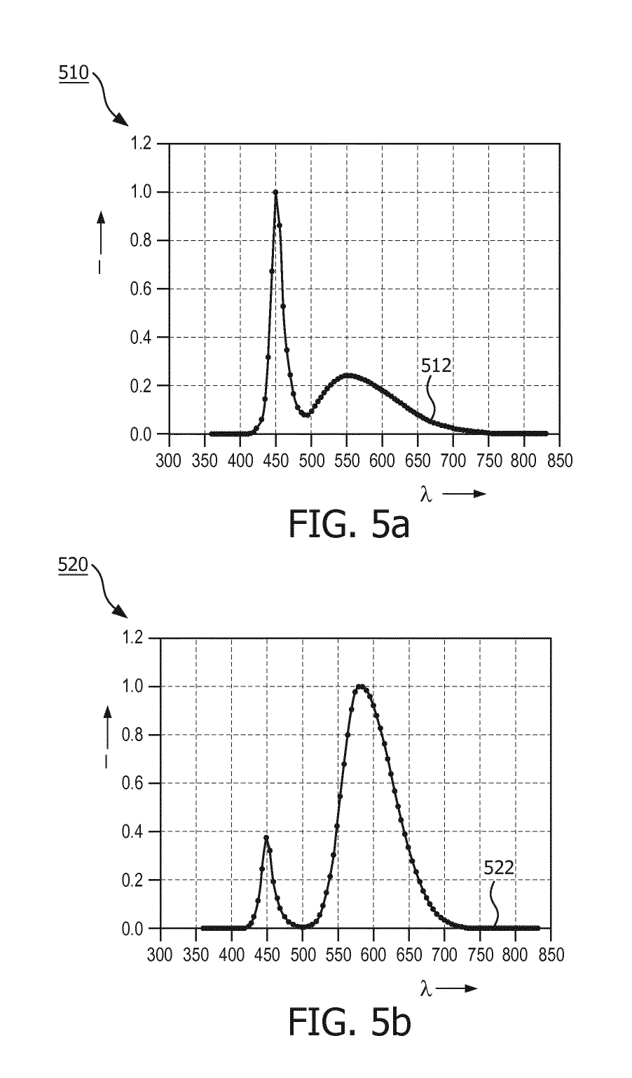

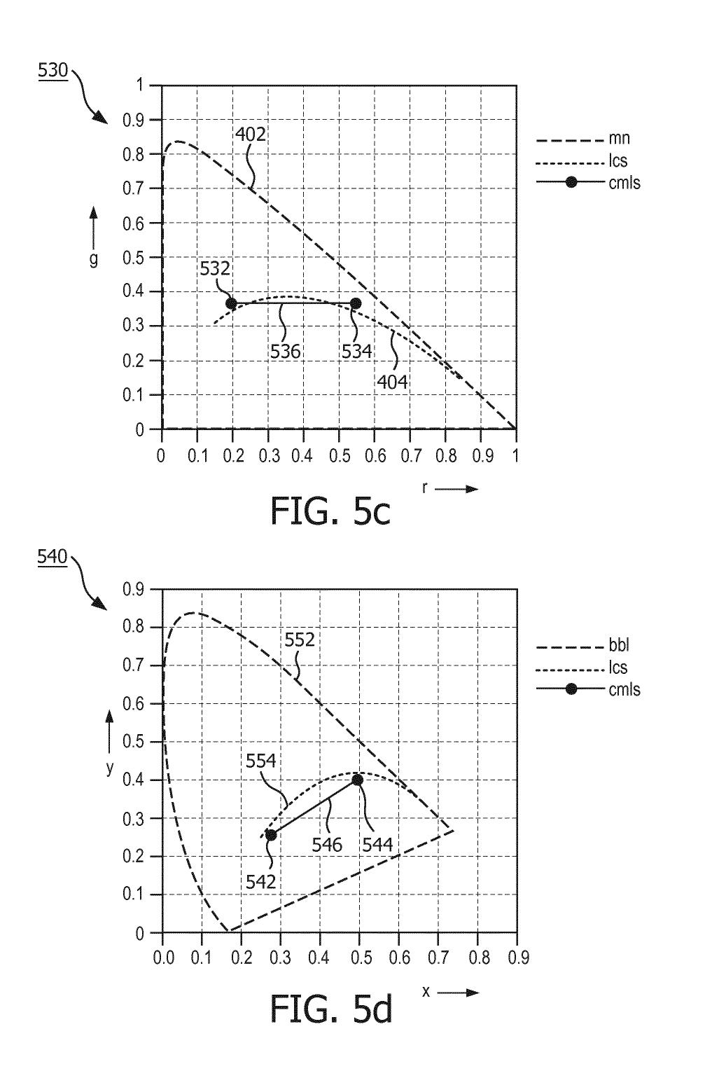

FIGS. 5a to 5d present characteristics of light sources used in an example of a color matched light source of an example of the image capturing system of, for example, FIG. 3. FIG. 5a presents in chart 510 an example of a light emission spectrum of a first light source. The x-axis represents the wavelengths λ of light and the y-axis represents the (relative) intensity I (i.e. power density) of the emitted light at the specific wavelengths. Line 512 represents for the example of the first light source the intensity of light in dependence of the wavelength. The light emission spectrum represents relatively cool white light. The color point in the color space of the image capturing sensor is close to a color point of light emitted by a black body radiator having a temperature of 14,000 Kelvin. The example of the first light source comprises a Light Emitting Diode (LED) emitting blue light having a peak wavelength at 450 nm. The example of the first light source also comprises a luminescent material that has a relatively wide light emission spectrum that has a peak wavelength at about 550 nm. In the example the luminescent material is the yellow emitting inorganic YAG phosphor. The amount of the luminescent material and the arrangement of the luminescent material with respect to the LED are selected such that the combined light emission spectrum of FIG. 5a is obtained.

FIG. 5b presents in chart 520 an example of a light emission spectrum of a second light source. The x-axis represents the wavelengths λ of light and the y-axis represents the (relative) intensity I of the emitted light at the specific wavelengths. Line 522 represents for the example of the first light source the intensity of light in dependence of the wavelength. The light emission spectrum represents relatively warm white light. The color point in the color space of the image capturing sensor is close to a color point of light emitted by a black body radiator having a temperature of 2,270 Kelvin. The example of the second light source comprises a Light Emitting Diode (LED) emitting blue light having a peak wavelength at 450 nm. The example of the second light source also comprises a luminescent material that has a relatively wide light emission spectrum that has a peak wavelength at about 580 nm. In the example, the luminescent material is an amber color emitting luminescent material, such as, for example BSSN or Barium Strontium Nitride. The amount of the luminescent material and the arrangement of the luminescent material with respect to the LED are selected such that the combined light emission spectrum of FIG. 5b is obtained. It is to be noted that the luminescent material absorbs a lot of the blue light emitted by the solid state light emitter and converts this to a relatively large amount of light having the color distribution with the peak wavelength of 580 nm.

FIG. 5c presents in chart 530 a color space of an image capturing sensor which has, for example, the spectral response of FIG. 1b. Line 402, mn represents the mono-line of single wavelength light emission spectra and line 404, lcs is the locus line. A first color point 532 is of the first light source having the light emission spectrum 512 as presented in FIG. 5a. A second color point 534 is of the second light source having the light emission spectrum 522 as presented in FIG. 5b. The line 536, cmls between the first color point 532 and the second color point 534 represents all color point of light that can be emitted by a color matched light source (of e.g. the image capturing system 300 of FIG. 3) that comprises the first light source and the second light source according to the example of FIGS. 5a and 5b. As is seen in FIG. 5c, the color matched light source is able to emit light that has a color point that is, in the color space of the image capturing sensor, relatively white light.

For reference, in chart 540 of FIG. 5d, color points 542, 544 of the light emission of the first light source and the second light source of FIGS. 5a and 5b, respectively, are presented in the CIEXYZ color space. The color space presented in FIG. 5d is the CIEXYZ color space that is based on the sensitivity of the human naked eye to light (as is discussed in the context of FIG. 1a) and thus represents how the human naked eye experiences the color of a specific light emission spectrum. The color points in this color space are calculated based on formulas (1) and (2). The x-axis represents the x-value of the color points and the y-axis represents the y-value of the color points. Line 552, mn is the mono-line in the CIEXYZ color space and represents for the largest parts color points of single wavelength light emission spectra. Line 554, bbl is the black body line representing color point of light emitted by black body radiators having different temperatures. A third color point 542 is the color point in the CIEXYZ color space of the light emitted by the first light source as represented by light intensity distribution 512 of FIG. 5a. A fourth color point 544 is the color point of the light emitted by the second light source as represented by light intensity distribution 522 of FIG. 5b. It is seen that the color points 542, 544 are located slightly below the black body line 554 and, thus, that the line 546, cmls between the color point 542, 544 is located below the black body line 554. Thus, although that light emitted by the color matched light source comprising the first light source and the second light source is captured by the image capturing sensor as relatively white light, the human naked eye experiences these light emissions as off-white light and the human naked eye shall experience the color purple in these light emissions.

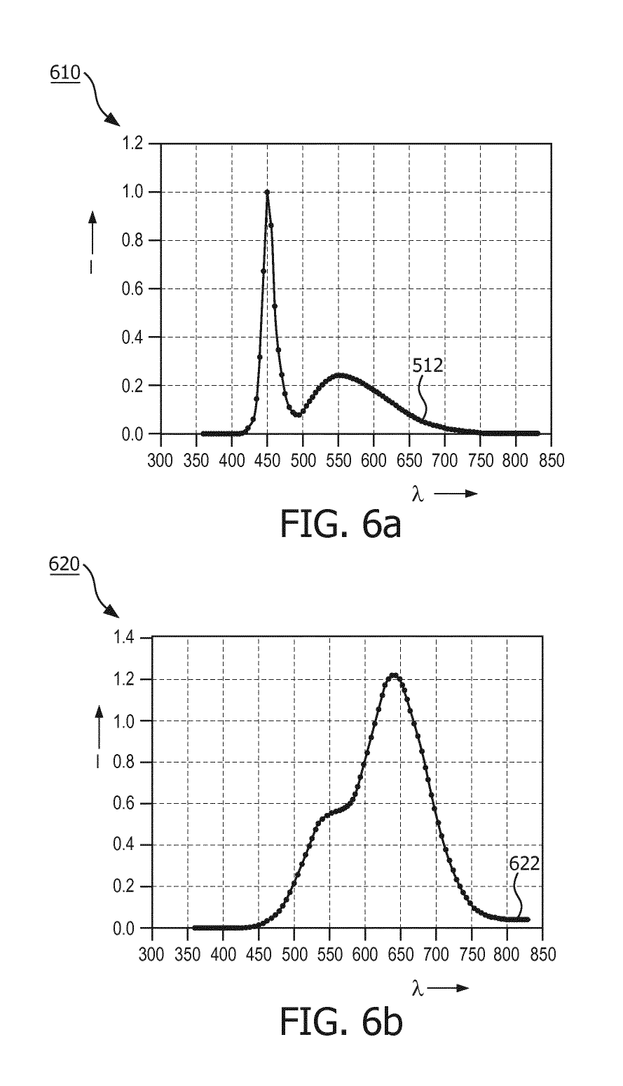

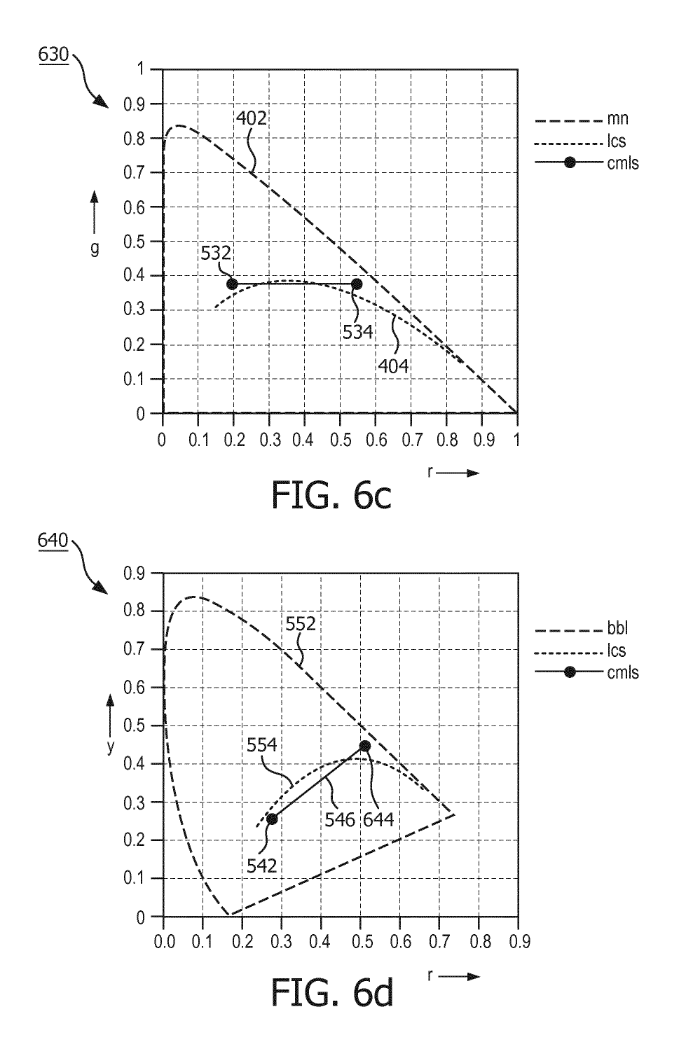

FIGS. 6a to 6d present another example of light emission spectra and their corresponding color points of a first light source and a second light source of a color matched light source of an image capturing system according to, for example, FIG. 3. Chart 610 of FIG. 6a presents a light emission spectrum 512 that is equal to the light emission spectrum 512 of FIG. 5a and, thus, relates to about the same first light source. Chart 620 of FIG. 6b presents a light emission spectrum 622 of the second light source of the another example. The second light source comprises a LED emitting a red color light having a peak wavelength of 450 nm. The second light source comprises a luminescent material emitting amber colored light in a relatively wide spectral range and having a peak wavelength of 640 nm. An example of the luminescent material is an inorganic phosphor that is indicated with BR101a. Alternatively, the luminescent material is an inorganic phosphor that is indicated with BR106a. The color point of this light is, in the color space of the image capturing sensor, close to a color point of light emitted by a black body radiator having a temperature of 2,340 Kelvin. It is seen in FIG. 6b that the light emission spectrum 622 is different from the light emission spectrum 522 of FIG. 5b and, thus, the second light source emits light that has different properties. However, as shown in chart 630 of FIG. 6c, the color point 634 of the light emission spectrum 622 in the color space of the image capturing sensor is about the same color point as the color point 534 of the light emission spectrum 522. It has been discussed earlier that different light emission spectra may lead to the same color point. For sake of clarity, FIG. 6c presents in the color space of the image capturing sensor color points 532, 634 of light emitted by the examples of the first light source and second light source of FIGS. 6a and 6b. FIG. 6d shows in the CIEXYZ color space the color points 542, 644 of the light emitted by the examples of the first light source and second light source of FIGS. 6a and 6b. Color point 542 is of the light emitted by the first light source. Color point 644 relates to the light emitted by the second light source as presented in FIG. 6b. It is seen, when FIG. 6d and FIG. 5d are compared, that the color point 644 has another position in the CIEXYZ color space and that the line 646, cmls between the color points 542, 644 is relatively close to the black body line 554. Thus, when the color matched light source of this example emits light, this light is captured by the image capturing sensor as relatively white light and is seen by the human naked eye as relatively white light.

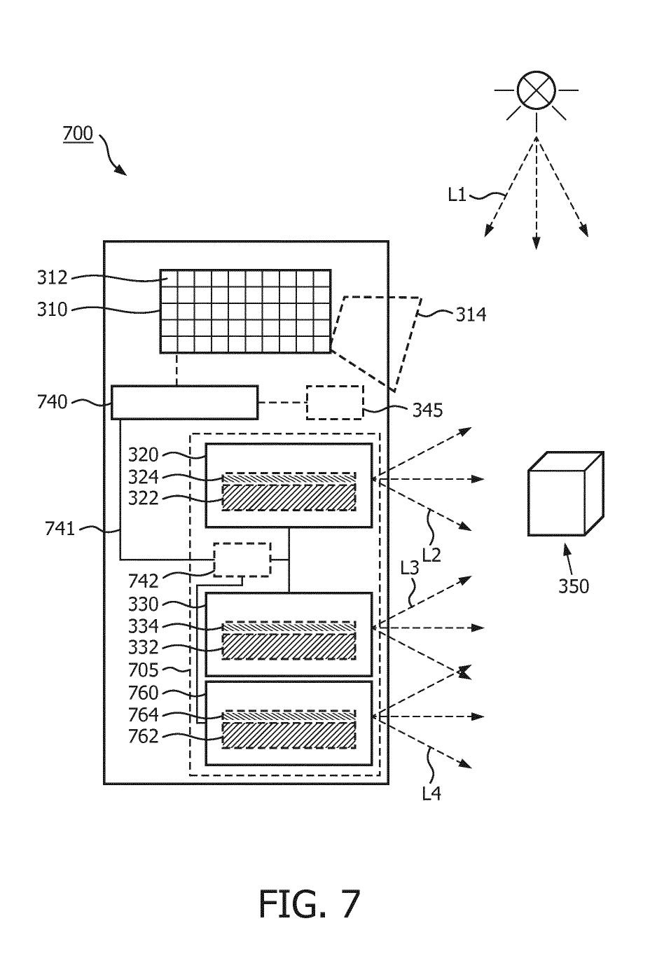

FIG. 7 schematically presents an image capturing system 700 which is similar to the image capturing system 300 of FIG. 3, but additionally comprises a third light source 760 as one of the light sources of the color matched light source 705. As a consequence of the presence of the third light source 760, the controller 740, the control signals 741 and the driving circuitry 742 may be different as well. The third light source 760 is configured to emit, in use, a third light emission spectrum having a third color point in the color space of the image capturing sensor. The third light emission spectrum is selected to obtain a green value for the third color point that is larger than the maximum green value of all color points on the locus line and that it has a red-value in a range from 0.2 to 0.4. Furthermore, a distance from the third color point to a nearest point of the locus line is smaller than 0.15. Thus, the third light source emits white light that has a slightly greenish appearance when being captured by the image capturing sensor 310 of the image capturing system 700. The controller 740 does not only generate control signals 741 for the first light source 320 and the second light source 330, but also for the third light source 760. The controller 740 takes into account characteristics of the ambient light, as discussed previously, and generates control signals to control the light emissions of the light sources 320, 330, 760 to obtain a combined light emission that is about similar to the ambient light (when being captured by the image capturing sensor 310). Optionally, the image capturing system 700 comprises a driving circuitry 742 that receives the control signals 741 and controls an amount of driving power provided to the light source 320, 330, 760 in accordance with the received control signals 741.

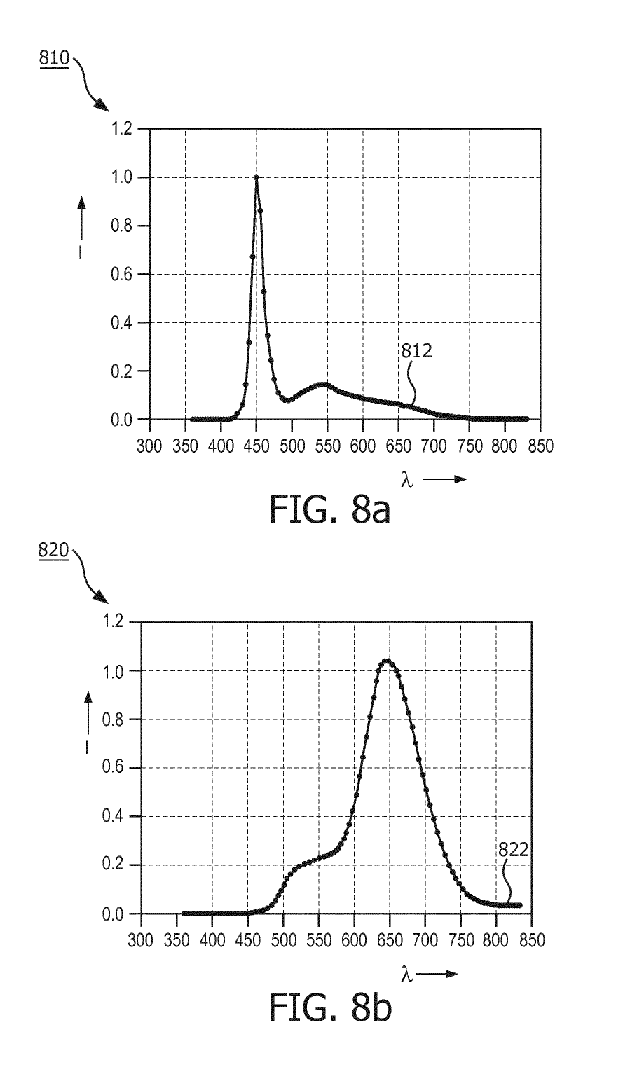

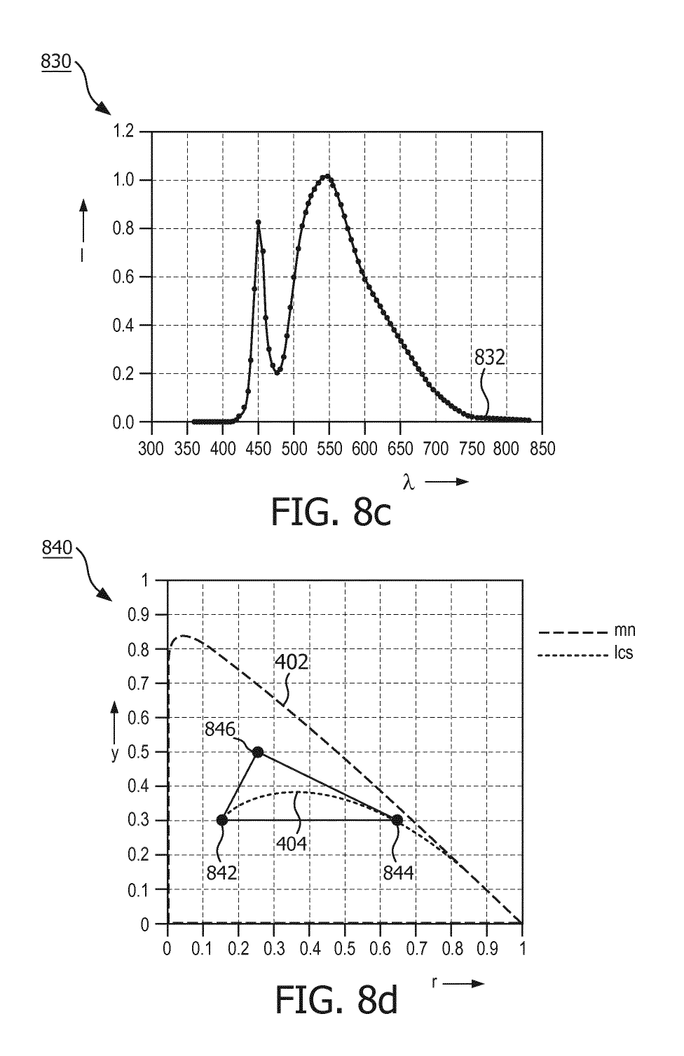

FIGS. 8a to 8d relate to an example of light sources of the image capturing system 700 of FIG. 7. The figures discuss characteristics of the light sources. FIGS. 8a to 8c present light emission spectra of the first light source, the second light source and the third light source, respectively. FIG. 8d presents the color point of these light emission spectra in the color pace of the image capturing sensor. FIG. 8a presents in a chart 810 an example of a light emission spectrum 812 of a first light source. The first light source comprises a blue emitting LED having a peak wavelength of about 450 nm. The light source further comprises a first luminescent material (in this case the inorganic phosphor YAG) which emits light in a relatively wide light emission spectrum with a peak wavelength of about 550 nm. The amount of provided first luminescent material is relatively low and only a small portion of the blue light is converted towards the yellow light emitted by inorganic phosphor YAG. The color point of the light of the first light source, in the color space of the image capturing sensor, is close to a color point of light emitted by a black body radiator having a temperature of 9,000 Kelvin. FIG. 8b presents in a chart 820 an example of a light emission spectrum 822 of the second light source. The second light source comprises a blue emitting LED that has a peak wavelength at 450 nm. The second light source also comprises a second luminescent material that emits red light in a relatively wide light emission spectrum having a peak wavelength at about 640 nm. An example of the luminescent material is an inorganic phosphor that is indicated with BR101a. Alternatively, the luminescent material is an inorganic phosphor that is indicated with BR106a. The color point of the light of the second light source, in the color space of the image capturing sensor, is close to a color point of light emitted by a black body radiator having a temperature of 1,770 Kelvin. FIG. 8c presents in chart 830 an example of a light emission spectrum 832 of the third light source. The third light source comprises a blue emitting LED having a peak wavelength of about 450 nm. The third light source also comprises a greenish/yellow emitting third luminescent material (in this example the inorganic phosphor LuAG) emitting light in a relatively wide spectral range and having a peak wavelength at about 550 nm. The amount of used third luminescent material is such that a significant part of the blue light is absorbed and converted towards the greenish/yellow light emitted by the third luminescent material. Consequently, the light emitted by the third luminescent material is relatively white but has a greenish color when being captured by the image capturing sensor. FIG. 8d presents in chart 840 the color points 842, 844, 846 of the first light source, the second light source and the third light source, respectively, in the color space of the image capturing sensor. As in previous examples of the color space of the image capturing sensor, line 402, mn is the mono-line and line 404, lcs is the locus line. It is seen that the color points 842, 844 of the light emitted the first light source and the second light source, respectively, are close to the black body line 404. The color point 846 of the light emitted by the third light source (in accordance with the light emission spectrum 832 of FIG. 8c) is located above the locus line 404 and is recorded as a relatively greenish white. The red-value of the color point 846 is about 0.25, which is in between 0.2 and 0.4. The triangle between the color points 842, 844, 846 encloses all color points that can be emitted by the color matched light source comprising the first light source, the second light source and the third light source. The controller of the image capturing system may generate control signals such that the combined light emission of the first light source, the second light source and the third light source has a color point within the triangle such that is matched to the largest extent characteristics of the ambient light (when being captured by the image recording sensor).

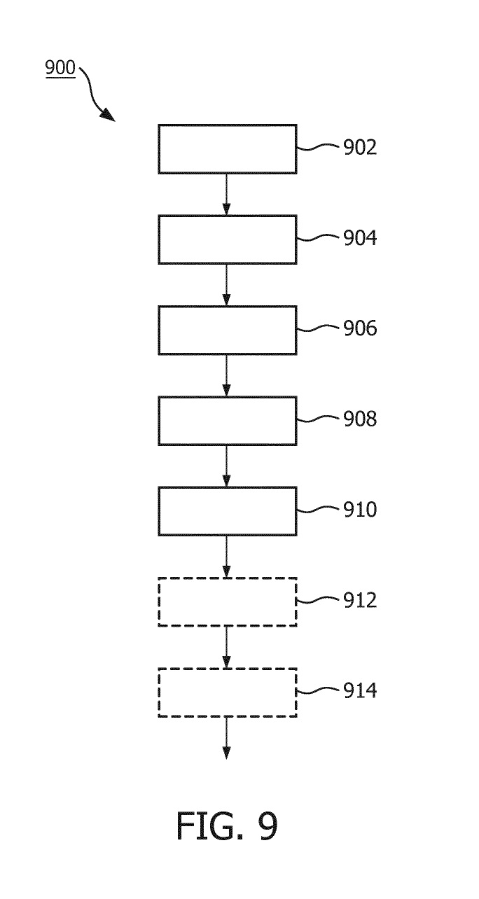

FIG. 9 presents a method 900 of configuring a color matched light source for use as a flash light source in a predefined image capturing system. The predefined image capturing system is for obtaining a captured image having a substantially equal color reproduction in a portion illuminated by ambient light and a portion illuminated by a color matched light source of the image capturing system. The predefined image capturing system comprises an image capturing sensor. The color matched light source comprises a first light source and a second light source. The method 900 comprising a) determining 902 predefined spectral responses of the image capturing sensor of the image capturing system, the predefined spectral responses describe a response of the image capturing sensor to different colors while obtaining color values for pixels of a captured image, wherein the color values of a single pixel describe a specific color point in the color space of the image capturing sensor; b) determining 904 a first color point in the color space of the image capturing sensor; c) determining 906 a second color point in the color space of the image capturing sensor, wherein the first color point and the second color point are determined to obtain a line between the first color point and the second color point that at least partially intersects with a first area and a second area, the first area being defined by a predefined distance to a color point on a locus line of light emitted by a black body radiator having a first temperature, the second area being defined by a predefined distance to a color point on the locus line of light emitted by a black body radiator having a second temperature, the predefined distance is smaller than 0.05, the first temperature is in a range from 5,000 to 20,000 Kelvin, the second temperature is in a range from 1,500 to 3,500 Kelvin, the color space of the image capturing sensor is represented by a two dimensional color space based on an amounts of red and of green light relative to a total amount of light, the locus line represents color points of light emitted by black body radiators having different temperatures; d) selecting 908 the first light source, the first light source is configured to emit a first light emission having the determined first color point; e) selecting 910 the second light source, the second light source is configured to emit a second light emission having the determined second color point. Optionally, the color matched light source comprises a third light source and the method further comprises f) determining 912 a third color point in the color space of the image capturing sensor, a green value of the third color point is larger than the maximum green value of all color points on the locus line; and g) selecting 914 the third light source, the third light source is configured to emit a third light emission having the determined third color point.

It is to be noted that the determining a color point and selecting a light source having this color point in the color space of the image recording sensor may be performed in parallel, or one may iterate a few times between these two actions. For example, when a color point is determined, it might be difficult to select a light source that has exactly this color point, which might result in adapting the color point and further adapting the selected light source.

Hereinafter, a more formalistic approach is discussed to further explain the selecting of a specific light source (such as, for example, the first light source, the second light source and/or the third light source) when it is known what color point (r,g) the light emission should have in the color space of the image capturing sensor. It is assumed that the specific light source comprises one solid state light emitter and one or more phosphor materials. When one selects a specific solid state light emitter, one knows or one may determine the light emission spectrum Iₛₛₗₑ(λ) of this solid state light emitter. Subsequently, there is a choice for different phosphor material that each have a light emission spectrum I_{Pn}(λ). Subsequently, the light emission of the color matched light source can be described by the function

Iₗₛ(λ)=α₀Iₛₛₗₑ(λ)+α₁I_{P1}(λ)+ . . . +αₙI_{Pn}(λ) (5)

Subsequently a vector α=(α₀, α₁, . . . , αₙ) for formula (5) must be found such that,

$$r = \frac{{R}_{ls}}{{R}_{ls} + {G}_{ls} + {B}_{ls}} \pm δ$$

$$and$$

$$g = \frac{{G}_{ls}}{{R}_{ls} + {G}_{ls} + {B}_{ls}} \pm δ ,$$

wherein, Rₗₛ=∫Rᵢ(λ)·Iₗₛ(λ)dλ, Gₗₛ=∫Gᵢ(λ)·Iᵢₛ(λ)dλ and Bₗₛ=∫Bᵢ(λ)·Iₗₛ(λ)dλ are the color values of light emitted by the specific light source as recorded by the image capturing sensor; Rᵢ(λ), Gᵢ(λ) and Bᵢ(λ) are the spectral response of the image capturing sensor for the color Red, Green and Blue; r and g are the color values of the required color point; Iₗₛ(λ) describes the specific light emission spectrum of the specific light source as defined in formula (5); and δ is an accepted tolerance (for example, δ<=0.01). A further boundary condition must be defined to define how the factors α₀, α₁, . . . , αₙ relate to each other, e.g., when a relatively large amount of a first phosphor material is used, α₁ increases and α₀ decreases. The relations between the factors α₀, α₁, . . . , αₙ also depend on how and where the phosphor material is arranged with respect to solid state light emitter and how the different phosphor materials are arranged with respect to each other. Optical models may provide input for the boundary conditions for and relations between the factors α₀, α₁, . . . , αₙ.

The above discussed mathematical problem of finding a vector α may provide one or more solutions for the vector α=(α₀, α₁, . . . , αₙ). Each solution provides a specific light source that has about the required color point. One of the solutions may be selected. The factors α₀, α₁, . . . , αₙ define the amount of phosphor materials to be used and how they must be arranged with respect to the selected solid state light emitter.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements. In the device claim enumerating several means, several of these means may be embodied by one and the same item of hardware. The mere fact that certain measures are recited in mutually different dependent claims does not indicate that a combination of these measures cannot be used to advantage.

1. An image capturing system for obtaining a captured image having a substantially equal color reproduction in a portion illuminated by ambient light and a portion illuminated by a color matched light source of the image capturing system, the image capturing system comprising:
an image capturing sensor for capturing a captured image comprising pixels, the image capturing sensor being configured to obtain color values relating to different color components for the pixels according to spectral responses for the different colors components, wherein the color values of a single pixel represent a specific color point in the color space of the image capturing sensor,
a color matched light source for use as a flash light source of the image capturing system, the color matched light source comprising
a first light source having a first light emission spectrum having a first color point in the color space of the image capturing sensor,
a second light source having a second light emission spectrum having a second color point in the color space of the image capturing sensor,
a controller configured to
i) receive characteristics of the ambient light, the characteristics being indicative of a correlated color temperature of the ambient light, an estimated color point of the ambient light or a color distribution of the ambient light, and
ii) in dependence of the received characteristics of the ambient light, determine control signals for controlling a light emission of the first light source and of the second light source to obtain a combined light emission matching the characteristics of the ambient light,
wherein the first light emission spectrum and the second light emission spectrum are selected for emitting light that is, in the color space of the image capturing sensor, close to a locus line in a dynamic range of which borders are defined by a first reference color point of a black body radiator having a first temperature and a second reference color point of a black body radiator having a second temperature such that the first color point is at least a predefined distance away from the locus line or the second color point is at least the predefined distance away from the locus line,
while a line between the first color point and the second color point at least partially intersects with a first area and a second area, the first area being up to the predefined distance from the first reference color point, the second area being up to the predefined distance from the second reference color point, the predefined distance is smaller than 0.05, the first temperature is in a range from 5,000 to 20,000 Kelvin, the second temperature is in a range from 1,500 to 3,500 Kelvin.

2. An image capturing system according to claim 1, wherein all color points on a portion of the line between the first area and the second area have a shortest distance to the locus line that is smaller than the predefined distance.

3. An image capturing system according to claim 1, the color matched light source further comprising a third light source having a third light emission spectrum having a third color point in the color space of the image capturing sensor, the third light emission spectrum being selected to have a green value for the third color point that is larger than the maximum green value of all color points on the locus line,
wherein
the controller is further configured to determine, in dependence of the received characteristics of the ambient light, the control signals that comprise a control signal for controlling a light emission of the third light source to obtain the combined light emission.

4. An image capturing system according to claim 3, wherein the first light emission spectrum, the second light emission spectrum and the third light emission spectrum are selected to obtain a triangle that at least overlaps a portion of the locus line, wherein the triangle is defined by the first color point, the second color point and the third color point, the portion of the locus line representing color points of light emitted by different black body radiators having different temperatures in a range from 2,700 Kelvin to 6,500 Kelvin.

5. An image capturing system according to claim 1, wherein the controller is further configured to determine the control signals to obtain the combined light emission having a combined light emission spectrum that has in the color space of the image capturing sensor a combined color point that is close to the locus line.

6. An image capturing system according to claim 5, wherein the controller is further configured to determine the control signals to obtain the combined color point having a distance to the locus line smaller than the predefined distance.

7. An image capturing system according to claim 1, wherein the received characteristics of the ambient light comprise a correlated color temperature value of the ambient light and the controller is configured to determine the control signals to obtain the combined light emission having a combined light emission spectrum that has in the color space of the image capturing sensor a combined color point for which a distance between the combined color point to a color point of a black body radiator having a temperature substantially equal to the correlated color temperature is minimized.

8. An image capturing system according to claim 1, wherein the controller is further configured to determine a fourth color point of the ambient light in the color space of the image capturing system, and the controller is further configured to determine the control signals to obtain the combined light emission having a combined light emission spectrum that has in the color space of the image capturing sensor a combined color point for which a distance between the combined color point to the fourth color point is minimized.

9. An image capturing system according to claim 1, wherein
the first light source comprises a first solid state light emitter for emitting light having a first color distribution and comprises a first luminescent material arranged to receive light emitted by the first solid state light emitter, configured to absorb a portion of the light of the first color distribution and configured to convert a portion of the absorbed light towards light of a second color distribution being different from the first color distribution, and/or
the second light source comprises a second solid state light emitter for emitting light having a third color distribution and comprises a second luminescent material arranged to receive light emitted by the second solid state light emitter, configured to absorb a portion of the light of the third color distribution and configured to convert a portion of the absorbed light towards light of a fourth color distribution being different from the third color distribution,
and/or
the third light source comprises a third solid state light emitter for emitting light having a fifth color distribution and comprises a third luminescent material arranged to receive light emitted by the third solid state light emitter, configured to absorb a portion of the light of the fifth color distribution and configured to convert a portion of the absorbed light towards light of a sixth color distribution being different from the fifth color distribution.

10. An image capturing system according to claim 1 comprising at least one of:
an ambient light sensor for determining characteristics of the ambient light, the ambient light sensor (245) being coupled to the controller,
a light source driving circuit for driving the first light source and the second light source according to the control signals received from the controller.

11. A mobile phone comprising an image capturing system according to claim 1.

12. Use of an image capturing system according to claim 1.

13. A method of configuring a color matched light source for use as a flash light source in an predefined image capturing system, the predefined image capturing system is for obtaining a captured image having a substantially equal color reproduction in a portion illuminated by ambient light and a portion illuminated by a color matched light source of the image capturing system, the predefined image capturing system comprising an image capturing sensor, the color matched light source comprising a first light source and a second light source, the method comprising:
determining predefined spectral responses of the image capturing sensor of the image capturing system, the predefined spectral responses describe a response of the image capturing sensor to different colors while obtaining color values for pixels of a captured image, wherein the color values of a single pixel describe a specific color point in the color space of the image capturing sensor,
determining a first color point in the color space of the image capturing sensor,
determining a second color point in the color space of the image capturing sensor, wherein the first color point and the second color point are determined for emitting light that is close to a locus line in a dynamic range of which borders are defined by a first reference color point of a black body radiator having a first temperature and a second reference color point of a black body radiator having a second temperature such that the first color point is at least a predefined distance away from the locus line or the second color point is at least the predefined distance away from the locus line, while a line between the first color point and the second color point at least partially intersects with a first area and a second area, the first area being up to the predefined distance from the first reference color point, the second area being up to the predefined distance from the second reference color point, the predefined distance is smaller than 0.05, the first temperature is in a range from 5,000 to 20,000 Kelvin, the second temperature is in a range from 1,500 to 3,500 Kelvin,
selecting the first light source, the first light source is configured to emit a first light emission having the determined first color point,
selecting the second light source, the second light source is configured to emit a second light emission having the determined second color point.
